(19) United States
(12) Patent Application Publication
(10) Pub. No.: US 2009/0157408 A1
(43) Pub. Date: Jun. 18, 2009

(54) SPEECH SYNTHESIZING METHOD AND APPARATUS

(75) Inventor: Sanghun KIM, Daejeon-city (KR)

Correspondence Address: AMPACC LAW GROUP, 13024 Beverly Park Road, Suite 205, Mukilteo, WA, 98275, US

(73) Assignee: Electronics and Telecommunications Research Institute, Daejeon (KR)

(21) Appl. No.: 12/163,210

(22) Filed: Jun. 27, 2008

(30) Foreign Application Priority Data
Dec. 12, 2007 (KR) 10-2007-0128929

(51) Int. Cl. G10L 13/08

(52) U.S. Cl. 704/260; 704/E13.011

(57) ABSTRACT

The present invention relates to a speech synthesizing method and apparatus based on a hidden Markov model (HMM). Among code words that are obtained by quantizing speech parameter instances for each state of an HMM model, a code word closest to a speech parameter generated from an input text using a known method is searched. When the distance between the searched code word and the speech parameter generated by the known method is smaller to or equal to a threshold value, the searched code word is output as a final speech parameter. When the distance exceeds the threshold value, the speech parameter generated by the known method is output as the final speech parameter. The final speech parameter is processed to generate final synthesized speech for the input text.

### BACKGROUND OF THE INVENTION

1. Field of the Invention

The present invention relates to a speech synthesizing method and apparatus, and more particularly, to a speech synthesizing method and apparatus based on a hidden Markov model (HMM).

This work was supported by the IT R&D program of MIC/IITA [2006-S-036-02, Development of large vocabulary/interactive distributed/embedded VUI for new growth engine industries].

2. Description of the Related Art

A speech synthesis technology is a technology that mechanically synthesizes human's speech. A speech synthesis may be defined as automatically generating a speech waveform using a mechanical apparatus, an electronic circuit, or computer simulation. The speech synthesis is implemented by a software or hardware type using a speech synthesizer.

The speech synthesis technology may be classified into two systems, which are an automatic response system (ARS) and a text-to-speech (TTS) system, according to an application method. The ARS is a speech synthesis system that is used to synthesize only sentences each having a limited vocabulary and a syntactic structure. The TTS system is a speech synthesis system that receives an arbitrary sentence regardless of the amount of vocabulary and synthesizes speech.

In particular, the TTS system uses small synthesized units from the speech and language processing to generate speech for an arbitrary sentence. Specifically, the TTS system uses language processing to correlate an input sentence with a combination of predetermined synthesis units, and extracts intonations and duration from the sentence to determine prosody of synthesized speech. Since the TTS system generates speech by combining phonemes and syllables each serving as a basic unit of language, there is no limitation in the amount of synthesized vocabulary.

FIG. 3 shows a process of synthesizing speech using a speech synthesis system based on a hidden Markov model (HMM) according to the related art. The HMM is a statistical model that is used to randomly estimate a sequence of hidden states on the basis of a sequence of observations. In the HMM-based speech synthesis, since input texts are known, the input texts can correspond to the observations in the HMM, and since pronunciation methods of the texts are not known, the pronunciation methods can correspond to states in the HMM. Accordingly, the HMM-based speech synthesis system uses the HMM as a statistical model to generate synthesized speech for the input texts.

The input texts are output as synthesized speech through a text preprocessing step (Step S11), a part-of-speech tagging step (Step S12), a prosody generating step (Step S13), an HMM model selecting step (Step S14), a speech parameter generating step (Step S15), and a speech signal generating step (Step S16). An HMM model DB 10 stores HMM models that become criterions when selecting an HMM model needed in generating a speech parameter, and the HMM models are prepared in advance through a discipline process on off-line.

In the text preprocessing step (Step S11), figures, symbols, Chinese characters, and alphabetic letters are converted into Hangeul. In the part-of-speech tagging step (Step S12), word-phrases in a sentence are separated into a morpheme unit and the part-of-speech is tagged to each of the morphemes. In the prosody generating step (Step S13), information on phrase break prediction, intonations, duration, and the like is generated. In the HMM model selecting step (Step S14), an appropriate HMM model is selected from the HMM model DB 10 in consideration of a phoneme environment and a prosody environment, and the texts are combined in a sentence unit.

In the speech parameter generating step (Step S15), a speech parameter including a spectral parameter and an excitation signal, which is an essential element to restore a speech signal in a vocoder, is generated. In this case, the excitation signal is a signal corresponding to a source that simulates a tremor of the vocal bands in a source/filter vocoder model, and the spectral parameter corresponds to a filter coefficient of a filter that simulates shapes of a tongue and a mouth.

In the speech signal generating step (Step S16), the speech parameter is processed to generate a speech signal, and final synthesized speech is output.

However, in the HMM-based speech synthesizing method according to the related art, when generating the speech parameter, an HMM model is selected on the basis of an average value. For this reason, there is a problem in that the trajectory of the speech parameter on a time basis is over smoothed, which differs from natural speech. The oversmoothing becomes a main factor that causes obscure synthesized speech to be generated. Here, the “based on the average value” means that an average value of a Gaussian random distribution for each state of an HMM model is used as a speech parameter.

According to a method in the related art for solving the above-described problem, a change in global variance (GV) of a speech parameter, which is extracted from actual natural speech, is modeled using the Gaussian probability, and the resultant from the exemplified model is defined as a cost function that is weight-coupled to a previously generated HMM model such that an optimized speech parameter can be generated, thereby obtaining a speech parameter similar to natural speech. However, even though this method is used, there is a limitation in that a final generated speech parameter still sounds artificial and differs from natural speech, and thus, it is difficult to generate high-quality synthesized speech.

### SUMMARY OF THE INVENTION

Accordingly, the invention has been made to solve the above-described problems, and it is an object of the invention to provide a speech synthesizing method and apparatus based on an HMM that is capable of generating a speech parameter most similar to natural speech.

In order to achieve the above-described object, according to a first aspect of the invention, there is provided a speech synthesizing method. The speech synthesizing method includes selecting an HMM model from an HMM model DB and generating a speech parameter; searching, from a vector quantization code book that is composed of code words, which are obtained by subjecting speech parameters extracted from HMM models included in the HMM model DB to vector quantization, a code word closest to the generated speech parameter; outputting the searched code word as a final speech parameter when the distance between the searched code word and the generated speech parameter is smaller to or equal to a threshold value, and outputting the generated speech parameter as the final speech parameter when the distance exceeds the threshold value; and generating synthesized speech on the basis of the output final speech parameter.

According to a second aspect of the invention, there is provided a speech synthesizing method. The speech synthesizing method includes selecting an HMM model from an HMM model DB and generating a speech parameter; searching, from a vector quantization code book that is composed of code words, which are obtained by subjecting speech parameters extracted from HMM models included in the HMM model DB to vector quantization, a code word closest to the generated speech parameter; outputting the searched code word instead of the generated speech parameter as the final speech parameter; and generating synthesized speech on the basis of the output final speech parameter.

The searching of the code word from the vector quantization code book may include constructing the vector quantization code book to be composed of the code words, which are obtained by quantizing speech parameter instances for each state of the HMM model.

In the constructing of the vector quantization code book to be composed of the code words, the vector quantization code book may be constructed such that a size thereof is changed according to a degree of variance in the distance between the speech parameter instances, the number of speech parameter instances, or the degree of variance and the number of speech parameter instances.

The speech parameter may include an excitation signal and a spectral parameter, and in the searching of the code word from the vector quantization code book, the vector quantization may be performed using the spectral parameter.

According to a third aspect of the invention, there is provided a speech synthesizing method in which, from a vector quantization code book that is composed of code words, which are obtained by subjecting speech parameters extracted from HMM models to vector quantization, instead of a predetermined speech parameter, a code word closest to the predetermined speech parameter is output as a final speech parameter, and synthesized speech is generated on the basis of the output speech parameter.

According to a fourth aspect of the invention, a speech synthesizing apparatus includes a speech parameter generating unit that selects an HMM model from an HMM model DB and generates a speech parameter; a vector quantization code book searching unit that searches, from a vector quantization code book that is composed of code words, which are obtained by subjecting speech parameters extracted from the HMM models included in the HMM model DB to vector quantization, a code word closest to the generated speech parameter; a speech parameter comparing unit that outputs the searched code word as a final speech parameter when the distance between the searched code word and the generated speech parameter is smaller to or equal to a threshold value, and outputs the generated speech parameter as the final speech parameter, when the distance exceeds the threshold value; and a speech signal generating unit that generates synthesized speech on the basis of the output final speech parameter.

According to the invention, since it is possible to generate a speech parameter most similar to natural speech with respect to input texts, clear synthesized speech can be generated, which leads to an improvement in a speech quality.

### BRIEF DESCRIPTION OF THE DRAWINGS

FIG. 1 is a flowchart illustrating a speech synthesizing method according to an embodiment of the invention;

FIG. 2 is a diagram illustrating a structure of a speech synthesizing apparatus according to an embodiment of the invention; and

FIG. 3 is a flowchart illustrating a process of a speech synthesizing method according to the related art.

### DESCRIPTION OF THE PREFERRED EMBODIMENTS

Hereinafter, an exemplary embodiment of the invention will be described in detail with reference to the accompanying drawings.

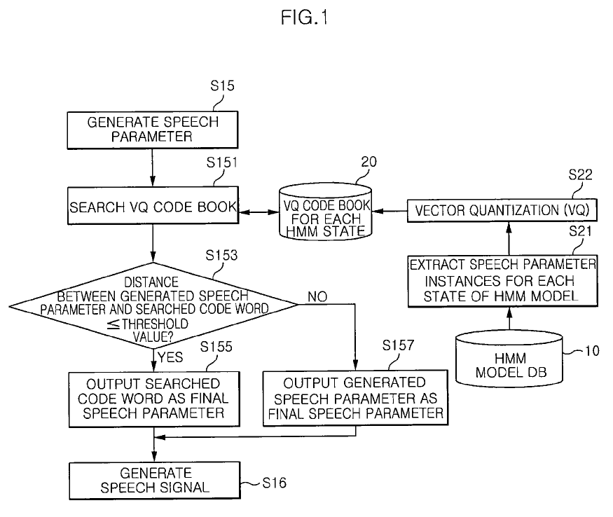

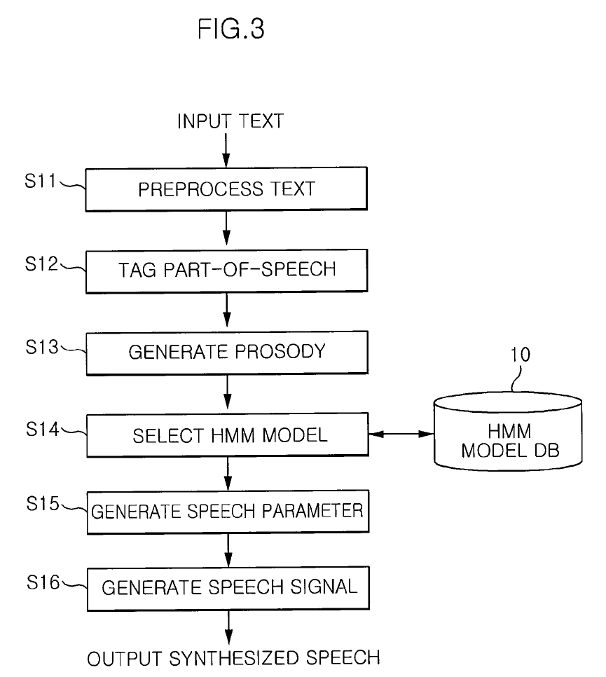

The invention relates to processes after a speech parameter generating step (Step S15) of a known speech synthesis process in FIG. 3. Therefore, the description of the processes up to the speech parameter generating step (Step S15) in FIG. 1 will be omitted. That is, the invention relates to whether to output a speech parameter generated by a speech synthesis process illustrated in FIG. 1 or a natural speech parameter of the invention. The same steps as those in FIG. 3 are denoted by the same reference numerals.

FIG. 1 shows a process of generating a speech parameter in a speech synthesizing method according to an embodiment of the invention. If a speech parameter for input texts is generated (Step S15), in the speech synthesizing method according to this embodiment, a code word that is closest to the generated speech parameter is searched from a VQ code book 20 for each HMM state (Step S151). The searched code word becomes a natural speech parameter that is extracted from the natural speech.

The VQ code book 20 for each HMM state extracts speech parameter instances included in individual states of HMM models from an HMM model DB 10 that is constructed through a discipline process on off-line (Step S21). The VQ code book 20 is composed of code words obtained by subjecting the extracted speech parameter instances to vector quantization (VQ) (Step S22). The speech parameter instances mean the speech parameters included in the individual states of the HMM models, respectively. Further, when the vector quantization is performed, a spectral parameter is used, but an excitation signal is not used.

In Step S153, if the distance between the searched code word and the generated speech parameter is smaller to or equal to a threshold value, the searched code word is output as a final speech parameter (Step S155). Final synthesized speech can be generated on the basis of the output final speech parameter. However, in this embodiment, if the distance between the searched code word and the generated speech parameter exceeds the threshold value, it is determined that a natural speech parameter that can be mapped does not exist in the VQ code book 20, and the speech parameter, which is generated through the previous process (Step S15), is output as the final speech parameter (Step S157).

That, if the distance between the searched code word and the generated speech parameter exceeds the threshold value, the searched code word (speech parameter) represents spectrum information of a considerably different characteristic from that of the generated speech parameter. As a result, when the searched code word is output as the final speech parameter, performance may be deteriorated. Accordingly, a size of the VQ code book 20 is changed in accordance with a degree of variance in the distance between the instances in the HMM states or the number of instances. That is, when the degree of variance or the number of instances is large, the VQ code book 20 is constructed to include a large amount of code words.

The threshold value is calculated through experiments. After synthesized speech is generated on the basis of an initial threshold value and a speech quality is determined, when the speech quality is deteriorated, the threshold value is recalculated and the speech quality is determined. The above-described processes are repeated, thereby determining an optimized threshold value.

Finally, a final speech parameter including an excitation signal is processed to generate a speech signal, and final synthesized speech for the input texts is output (Step S16). At this time, the excitation signal becomes a residual signal of the final speech parameter. The residual signal is a signal corresponding to a source (that is, excitation signal) that is generated when subjecting original speech to inverse-filtering using a spectral parameter (that is, filter coefficient).

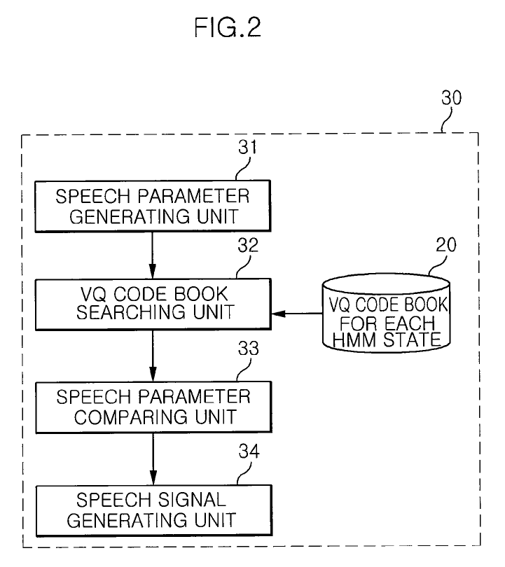

FIG. 2 shows a speech synthesizing apparatus 30 according to this embodiment. A speech parameter generating unit 31 performs the speech parameter generating step (Step S15) illustrated in FIG. 1 to generate a speech parameter. A VQ code book searching unit 32 performs the VQ code book searching step (Step 151) illustrated in FIG. 1 to search a code word closest to the generated speech parameter. A speech parameter comparing unit 33 performs the comparing step (Step S153) illustrated in FIG. 1 to determine whether the distance between the searched code word (that is, natural speech parameter) and the generated speech parameter is not more than the threshold value. According to the determination result, the speech parameter comparing unit 33 performs the steps S155 and S157 and outputs a final speech parameter. The speech signal generating unit 34 performs the speech signal generating step (Step S16) illustrated in FIG. 1 to output final synthesized speech for the input texts.

Although the exemplary embodiment described above is specified by the specific structure and the drawings, it should be understood that the present invention is not limited by the exemplary embodiment. Accordingly, it will be apparent to those skilled in the art that the present invention includes various modifications and equivalents thereof that do not depart from the scope and spirit of the present invention.

What is claimed is:

1. A speech synthesizing method comprising:
selecting an HMM model from an HMM model DB and generating a speech parameter;
searching, from a vector quantization code book that is composed of code words, which are obtained by subjecting speech parameters extracted from HMM models included in the HMM model DB to vector quantization, a code word closest to the generated speech parameter;
outputting the searched code word as a final speech parameter when the distance between the searched code word and the generated speech parameter is smaller to or equal to a threshold value, and outputting the generated speech parameter as the final speech parameter when the distance exceeds the threshold value; and
generating synthesized speech on the basis of the output final speech parameter.

2. A speech synthesizing method comprising:
selecting an HMM model from an HMM model DB and generating a speech parameter;
searching, from a vector quantization code book that is composed of code words, which are obtained by subjecting speech parameters extracted from HMM models included in the HMM model DB to vector quantization, a code word closest to the generated speech parameter;
outputting the searched code word instead of the generated speech parameter as the final speech parameter; and
generating synthesized speech on the basis of the output final speech parameter.

3. The speech synthesizing method of claim 1,
wherein the searching of the code word from the vector quantization code book includes:
constructing the vector quantization code book to be composed of the code words, which are obtained by quantizing speech parameter instances for each state of the HMM model.

4. The speech synthesizing method of claim 3,
wherein, in the constructing of the vector quantization code book to be composed of the code words, the vector quantization code book is constructed such that a size thereof is changed according to a degree of variance in the distance between the speech parameter instances, the number of speech parameter instances, or the degree of variance and the number of speech parameter instances.

5. The speech synthesizing method of claim 1,
wherein the speech parameter includes an excitation signal and a spectral parameter, and
in the searching of the code word from the vector quantization code hook, the vector quantization is performed using the spectral parameter.

6. A speech synthesizing method,
wherein, from a vector quantization code book that is composed of code words obtained by subjecting speech parameters extracted from HMM models to vector quantization, instead of a predetermined speech parameter, a code word closest to the predetermined speech parameter is output as a final speech parameter, and synthesized speech is generated on the basis of the output speech parameter.

7. A speech synthesizing apparatus comprising:
a speech parameter generating unit that selects an HMM model from an HMM model DB and generates a speech parameter;
a vector quantization code book searching unit that searches, from a vector quantization code book that is composed of code words, which are obtained by subjecting speech parameters extracted from the HMM models included in the HMM model DB to vector quantization, a code word closest to the generated speech parameter;
a speech parameter comparing unit that outputs the searched code word as a final speech parameter when the distance between the searched code word and the generated speech parameter is smaller to or equal to a threshold value, and outputs the generated speech parameter as the final speech parameter, when the distance exceeds the threshold value; and
a speech signal generating unit that generates synthesized speech on the basis of the output final speech parameter.
